(19) United States
(12) Patent Application Publication
(10) Pub. No.: US 2007/0044560 A1
(43) Pub. Date: Mar. 1, 2007

(54) Method and system for determining structural features of an acoustic material

(76) Inventors: Geir Instanes, Nesttun (NO); Dag Aldal, Fyllingsdalen (NO)

Correspondence Address: REED SMITH LLP, 3110 FAIRVIEW PARK DRIVE, FALLS CHURCH, VA, 22042, US

(21) Appl. No.: 10/555,652

(22) PCT Filed: May 5, 2004
(86) PCT No.: PCT/NO04/00128

§ 371 Date: Sep. 21, 2006

(30) Foreign Application Priority Data
May 5, 2003 (NO) 20032019

(51) Int. Cl. G01H 1/00; G01N 29/00; G01N 29/04

(52) U.S. Cl. 73/587; 73/592; 73/602

(57) ABSTRACT

A method is described to register structural features in an acoustic conducting material, such as the sheet material of a pipe, a duct, container or the like, where instrumentation fitted at the surface of the material, is used to emit and receive signals in/through the solid material and also to register changes in the received signals as a consequence of changes in the material structure. The method is characterised in that a sensor, or several sensors mutually spaced apart, is (are) arranged to be in contact with the surface of the material, and the sensor(s) is (are) arranged to emit and receive signals to provide an acoustic network with information about the structure of the material, and that the received acoustic signals are compared to previous acoustic signals to ascertain the existence of structural changes in the solid material, and any occurrences of defects in the solid material, and also the position of such defects. A system to carry out the method is also described.

The present invention relates to a method to register the structural features of an acoustic conducting material, such as the sheet material of a pipe, a duct, container or the like, where the instrumentation used is fitted onto the surface of the material and arranged to emit and receive acoustic signals in/through the solid material, and also to register changes in the received signals as a consequence of changes in the structure of the material.

The invention also relates to a system according to the introduction of claim 10.

The invention can be used on all acoustic conducting materials, for example, metal, plastic, ceramics and the like.

More exactly, the invention concerns a method to provide a survey of possible defects/damages, such as blemishes, cracks, recesses, erosion and corrosion, in the acoustic conducting solid material.

For pipelines that carry fluids, this can be defects which arise in the pipe wall as a consequence of erosion which the fluid flow itself and the solid particles in the fluid will exert on the inner walls. This occurs in particular in pipe bends, in areas where there are flanges and similar fittings, or where other fittings are connected, pipe branches etc. The invention has a particularly preferred application in all pipeline systems that are carrying fluids. With the expression fluid-carrying body one also means containers and tanks that store fluids. With fluids one means both gases and liquids, and also where these conduct larger or smaller fractions of solid particles, such as sand, dust and the like. The invention shall not be limited to pipe systems, but also relate to acoustic conducting materials in general and in the widest sense, as initially indicated.

To carry out measurements of different parameters such as flow velocities, amount of particles present in mixtures of liquids, hydrocarbons, gases and the like, or other parameters in fluids that flow through pipes or ducts, acoustic sensors or, for example, temperature and pressure sensors are used today. Such instruments are fitted onto or into the outer wall of the pipe or duct.

Concerning acoustic measuring instruments, these are equipped with both active and passive sensors where the active sensor emits an acoustic pulse which is reflected from the inner wall of the pipe wall, and where the passive part of the sensor listens to such acoustic pulses, for example, reflected pulses. The measuring instruments register the time it takes from when the acoustic pulse is emitted from the active sensor to when the reflected pulse is received by the passive sensor. Knowing the speed of sound in the pipe wall, the thickness of the pipe wall can be measured, and any blemish-forming erosion or corrosion of the pipe wall can be registered. Such blemishes are expressed by concavities or recesses. Or structural changes can arise in the pipe material, such as corrosion, which are difficult or impossible to visually detect.

The disadvantage with the previously known solutions is that one does not get information about where the defect/blemish can be found. Because the emitted acoustic pulse spreads out from the transmitter as rings in water, (i.e. as a shell of a ball expanding from the centre) one only gets to know the distance from the transmitter/receiver to the blemish. However one gets no information about the exact position of the blemish in the pipe surface or internally in the pipe.

It is an aim of the invention to be able to carry out measurements in a sheet material over a greater surface.

Furthermore it is an aim to be able to emit and receive acoustic signals in a solid material along the sheet material.

Furthermore, it is an aim to be able to carry out measurements around the round cross-section of a pipe.

It is an aim of the invention to provide a system which can determine the position of a defect in a solid material of the abovementioned type.

Furthermore it is an aim of the invention to provide a system which can be fitted permanently over a long time in connection to the acoustic conducting material.

The method and system according to the invention are characterised by the features that are given in the characteristics of the subsequent independent claims 1 and 10 respectively. Preferred embodiments of the method and system according to the invention are given in the respective dependent claims.

The invention shall be explained in more detail below with reference to the subsequent figures, in which;

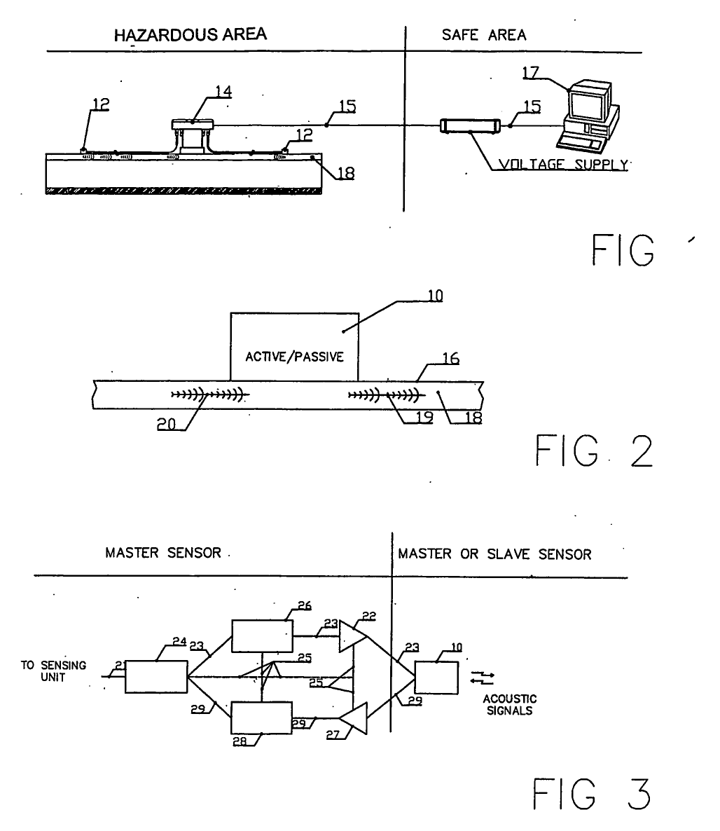

FIG. 1 shows schematically a measuring instrument which is fitted to a pipe, and shows the connection of the instrument to a computer and electricity supply.

FIG. 2 shows in more detail the connection of the sensor element to a pipe surface.

FIG. 3 shows schematically a block diagram of the connection of a sensor element.

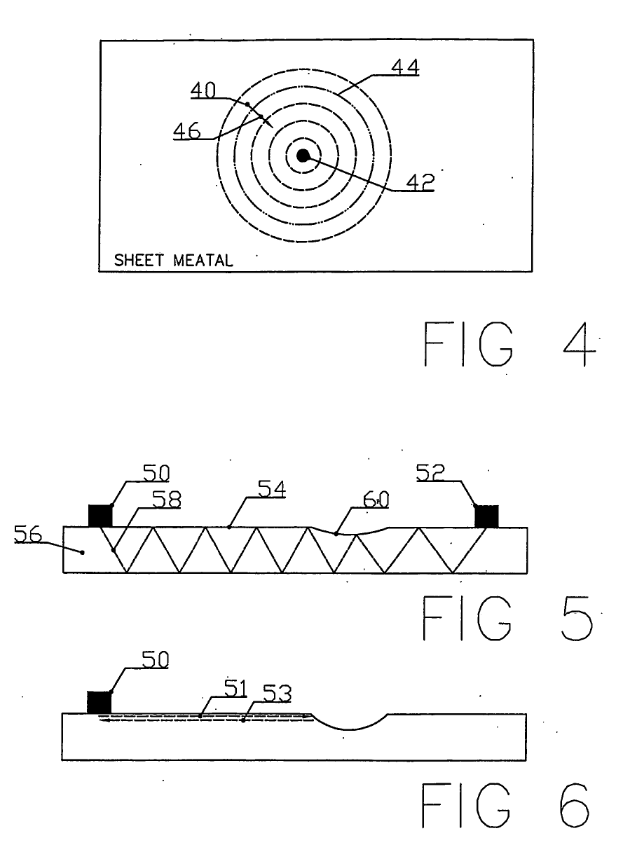

FIG. 4 shows how a signal which is emitted from a transmitter spreads out in a pipe material as rings in water.

FIG. 5 shows schematically how an emitted acoustic signal is sent out from a transmitter and reflected between the walls of a pipe material.

FIG. 6 shows schematically how an emitted acoustic signal is sent out along the longitudinal direction of a pipe.

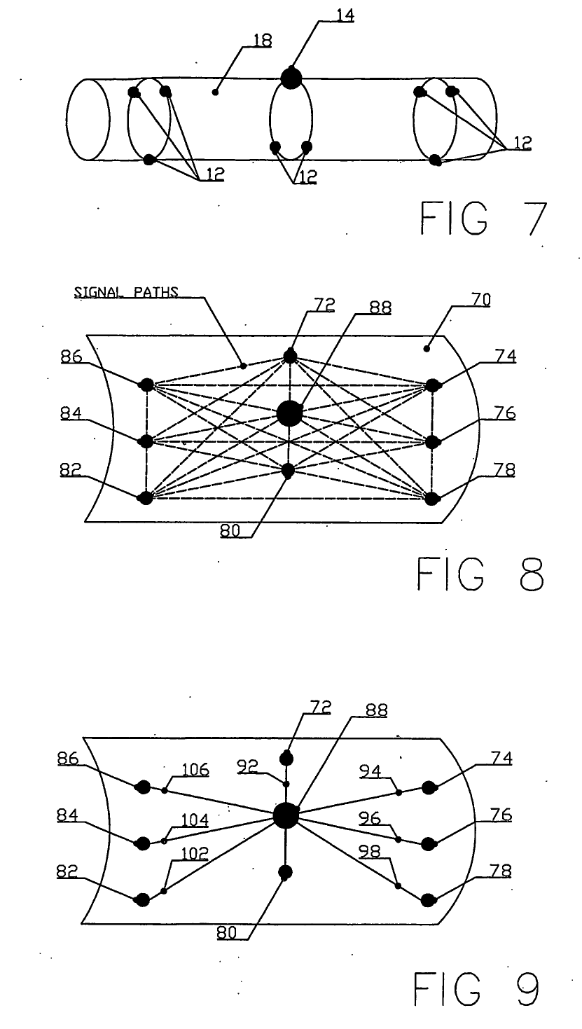

FIG. 7 shows the connection itself of a number of sensors to the surface of a piece of pipe.

FIG. 8 shows in more detail the connection of a number of sensors and the resulting signal paths.

FIG. 9 shows how the sensors can be mutually connected using cables.

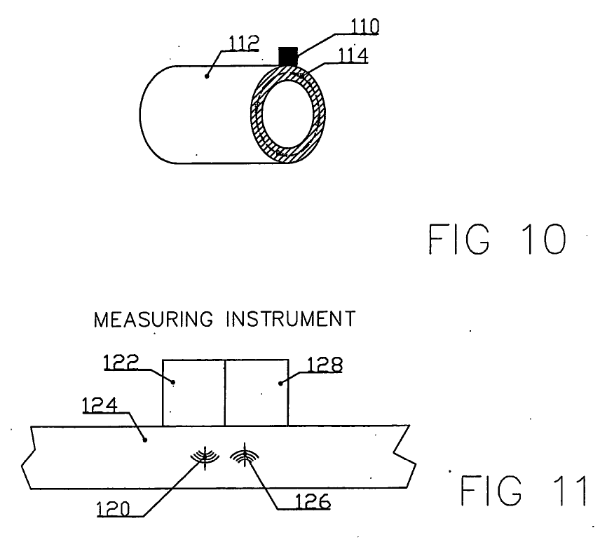

FIG. 10 shows a measuring situation where one sensor is connected to the surface of a piece of pipe.

FIG. 11 shows schematically the instrumentation for measuring the wall thickness according to today's method.

Schematically shown in FIG. 1 is the basic principle for the connection of one or more measuring instruments that, according to the invention, are connected to a pipe wall. The measuring instrument is fitted to a pipe 18, and comprises an ultrasound sensor (master sensor) arranged in a housing 14 in which an electronics card for registering of data is inserted. One or more slave sensors 12 can be optionally connected. Cables 15, which carry signals from the electronics cards to a computer (pc) 17 (for example, with associated keyboard and screen) or another computer that processes the signals and shows the results, run from the electronics cards. The electronics card itself, for the passively listening ultrasound sensor, can comprise a filter unit that can function as an adaptor module for the sensor with a tuned frequency. An amplifier step 22 which carries out an amplification within a given frequency range is shown in FIG. 3. The amplification step is controlled by the microprocessor (24) dependant on the noise level. The analog signals are converted to digital signals. A microprocessor treats and processes data, decides on amplification, filtering and transmission of data. A data transmission unit sends data to the computer via the transmission cable 21 in FIG. 3.

The sensor 10, shown in FIG. 2, can operate in two modes, active mode (transmission function) and passive mode (receiving function) and is fitted to the outer wall 16 of a pipeline 18 which is shown in a longitudinal cross-section. In active mode, acoustic signals 19 are emitted to the surface 16 of the pipe 18 and in passive mode reflected acoustic signals or signals from other sensors 20 are received from the surface.

A block diagram for the connection of a sensor element is shown schematically in FIG. 3. In active mode a signal 23 is sent from the micro-controller (MC) 24 which is converted (digital to analog) in a digital to analog converter 26 and is amplified in an amplifier 22 before transmission to the sensor element 10. Both conversion and amplification are controlled by the MC via control signals 25. The sensor element 10 can be either a master sensor or a slave sensor.

Correspondingly, in passive mode the sensor 10 will amplify in an amplifier 27 and convert (analog to digital) in an analog to digital converter 28 the signal 29 before it goes to the MC 24. Both conversion and amplification are controlled by the MC 24 via control signals 25. The sensor element 10 can be either a master sensor or a slave sensor.

The acoustic signal is sent to and through the body thereafter to be received by a sensor in passive made.

FIG. 4 shows a section of a body in a plane section, and where a recess/blemish 40 exists in the surface of the body. A sensor which is connected closely to the sheet material of the body emits a signal to the material at 42 and which spreads out as rings (waves) 44 over the sheet material. When the signals hit the recess/blemish, a signal 46 is reflected back to the sensor. The travel time and characteristic of the signal inform on how far from the sensor the blemish lies but not where it is positioned.

Two sensors 50,52 fitted to the surface 54 of a sheet 56 are shown in FIG. 5. When the sensor 50 emits an acoustic signal 58, a waveform is generated in the sheet and the wave moves through the sheet material and up to the receiver 52. When a blemish or a recess 60 in the surface 54 of the sheet arises between the sensors (50,52) over time, the signal path will change both with respect to time-course and characteristic. These changes will be registered by the measuring system and one can ascertain whether it is a structural change in the sheet surface or a change in the thickness of the sheet wall in the actual signal path.

FIG. 6 shows a sensor 50 which is fitted to a metal sheet, and where the sensor, in active mode, emits a signal 51 that runs along the sheet (in the solid sheet material). When the transmitted signal hits a defect in the form of a blemish/a recess 60 in the wall, a signal 53 is reflected which is registered by the sensor 50 in passive mode. As in FIG. 4, one knows the distance to the blemish in the pipe material, but not exactly where it is.

A solution to this problem has now been found, with determination of position of such defects in the form of recesses/blemishes in the pipe material. According to the invention a network of information is built up from several sensors (alternating between transmitter/receiver mode) which are distributed on a sheet surface.

An embodiment of the new method and system according to the invention is shown in FIG. 7. A master sensor 14 and a number of slave sensors 12 are arranged on the surface of a pipe 18.

FIG. 8 shows in more detail an example of the invention in FIG. 7 where a part of the piece of pipe 70 is shown folded out (a sheet form). A number of sensors 72,74,76,78,80,82,84,86 are arranged over the surface of the sheet 70. In addition, a master sensor 88 is set up. Each slave sensor 72-86, and also the master sensor 88 can alternate between operating in active and passive mode as shown in FIGS. 2 and 3, and are placed in contact with the sheet surface. The master sensor 88 comprises units for controlling the sensors 72-86, both with respect to when and how they shall emit acoustic signals, and their reception of such signals. Furthermore, the master sensor 88 comprises a transmitter and receiver unit which is also in contact with the sheet surface. The dotted lines between the sensors 72-88 in the figure show the signal paths between each individual sensor in the system, i.e. representing transmission and reception of such signals. More exactly, the figure shows that all the sensors are arranged to emit signals and also that they can receive signals from each of the other sensors.

Connection of slave sensors 72-86 which are connected with the cables 92, 94, 96, 98, 100, 102, 104 to the master sensor 88 is shown in FIG. 9.

Signals which are sent from each sensor 72-88 spread out in a circle from the sensor head and in a waveform as described above, cf. FIG. 4. If a defect (blemish or the like) arises in the solid sheet material within or outside the network of sensors, the position of the defect can be determined in the following way: The master sensor 88 instructs two or several of the sensors 72-86, possibly also itself, to emit acoustic signals to the sheet material 70. At the same time the sensors are instructed to register signals. If a defect (a blemish) in the pipe material has materialised since the last measurement (i.e. that the defect, for example, has materialised gradually over a long time), each of the sensors will register a changed signal due to this defect. All the signals are transmitted via the cables to the master sensor 88. The data which come in to the master sensor are now processed and a so-called cross-bearing of signals arriving from different angles in the solid sheet material is carried out. Thereby, one can ascertain where the defect (the blemish or the damage) is. The wall thickness can also be estimated from the same signals.

This means that the sensors communicate with each other in a network which thereby provides access to information about the thickness of the metal sheet or pipe sheet, and how this thickness changes over time as the measurements are carried out and the signals from the measurements are mutually compared.

The new system according to the invention, where a number of sensors are arranged spread out over the surface of a sheet, is suited for use on pipe lengths of some metres, for example, 1-2 metres. For pipes that transport particle-containing (such as sand-containing) fluids or at high fluid velocities, the system is particularly suited to be fitted on the pipe areas where erosion/wear is especially high, i.e. in pipe bends, or joins, or in areas where other equipment is connected. But it is also well suited to be used in connection with tanks and containers that hold fluids such as chemicals and where one wishes to have control over the quality in the form of sheet thickness and structure of the container walls. In such application, one can obtain an overview over whether the sheet material is corroding, eroding or is exposed to other kinds of wear or damage.

In practice, the method according to the invention can be carried out so that the system, permanently fitted to a pipe section, is set to operate, i.e. emit ultrasound pulses at given sequences, and with given intervals. Over a long time one will, for example, establish that no changes in the pipe material have taken pace, the signals show this in that they do not change. But if structural changes in the pipe wall occur (blemishes, recesses, corrosion and the like arise), the signals received by the sensors will change. Thereby, information is given both on whether a structural change (defect) in the solid pipe material has arisen and also one will be able to show by cross-bearings where this structural change is positioned in the sheet material. The same signals will also provide information about changes in the wall thickness of the sheet material.

An alternative embodiment of the inventions is shown in FIG. 10, where only one sensor 110, the master sensor, is fitted on a pipe 112. The sensor emits an acoustic signal 114 that transmits along the circumference of the pipe 112, and is returned to the same sensor which is now in passive (listening) mode. This signal will provide information about the wall thickness and any defects along a section of the pipe where the sensor is fitted.

FIG. 11 shows ultrasound for measuring of wall thickness as it is carried out today, in that a short acoustic pulse 120, typically a square pulse or a “spike” is emitted from an active sensor 122 and into the solid pipe material 124. This pulse is shaped to optimise detection of the signal travel time. Such a pulse is typically short, and with steep sides so that the time for the first reflected pulse 126 can easily be detected by the passive (listening) sensor 128. These types of signal pulses are well suited to be transmitted over short distances (to the inner wall of the pipe and back), but will, because of the dispersion, not be suited to be transmitted over longer distances, or along the pipe/sheet material.

In the present invention a signal is used which is optimised for being sent along the pipe material or the sheet material so that this signal can be sent between several individual sensors fitted on a surface. The sensor(s) and the signal are optimised not just to measure travel time for the first received pulse, but also to detect other changes in the signal characteristic, such as, for example, frequency content and speed. This leads to that the wall thickness for the actual signal path can be measured. For the same reason, signals that are reflected from defects that lie a distance from a sensor can be easier detected. In the present invention measurements can also be taken with just one sensor as the one and same sensor element is alternatively active (emits) and passive (receives). The same sensor element must here first be used actively to go over to become passive (listening). This is shown in FIG. 10.

With the new technology an emitted acoustic signal will typically be a sine pulse-train. A sine pulse will be comprised of several periods and is not suited to measurements over short distances which is typical for point-wall thickness meters. Sine signals will spread out in the sheet and will have a much greater reach than typical square pulses with the same effect. A received signal contains a mixture of emitted sine frequency and noise. A received signal is correlated against dispersion curves for the actual type of material to find the wall thickness.

In the present invention, measurements can, as described earlier, also be carried out with only one sensor as the one and same sensor element is alternatively active (emitting) and passive (receiving).

1. Method to register the structural features in an acoustic conducting material, such as the sheet material of a pipe, a duct, container and the like, where instrumentation is fitted on the surface of the material whereby acoustic signals are emitted from said instrumentation and received in/through the solid material, and also that changes in the received signals as a consequence of changes in the structure of the material are registered, characterised in that
a sensor, or several sensors mutually spaced apart, is (are) arranged in contact with the surface of the material, and the sensor(s) is (are) made to emit and receive signals to provide an acoustic network with information about the structure of the material, and
that the received acoustic signals are compared with previous acoustic signals to ascertain existing structural changes in the solid material, and
any occurrences of defects in the solid material, and also the position of such defects.

2. Method according to claim 1, characterised in that the position of a defect is determined by carrying out a so-called cross-bearing, i.e. by collating distance and angle between a number of individual sensors and the defect.

3. Method according to claims 1-2, characterised in that each sensor communicates with a control unit that is formed by one of the sensors, a so-called master sensor, with the master sensor regulating the transmission and reception of acoustic signals by the sensors.

4. Method according to one of the claims 1-3, characterised in that the master sensor controls the sensors to emit and receive acoustic signals with characteristics adapted to the measuring situation and surroundings.

5. Method according to one of the claims 1-4, characterised in that when the sensors emit and receive, respectively, acoustic signals with the same frequency, the signals are emitted with mutual time intervals.

6. Method according to one of the preceding claims, characterised in that when the sensors emit and receive acoustic signals at different frequencies, the signals are emitted simultaneously or with mutual time intervals.

7. Method according to one of the preceding claims, characterised in that the master sensor constitutes one of the sensors.

8. Method according to claim 1, characterised in that one single sensor, the master sensor, is applied and the information about the material structure is provided by registering reflections from the structure changes/defects in the sheet material.

9. Method according to claim 1, characterised in that the sensor is fitted to a pipe surface and acoustic signals are emitted/received to provide information about the structure (such as wall thickness) of the solid pipe material over a pipe cross-section.

10. System to register structural features in an acoustic conducting material, such as the sheet material of a pipe, a duct, container or the like, comprising instrumentation fitted onto the surface of the material and which is arranged to emit and receive acoustic signals in/through the solid material and also to register changes in the received signals as a consequence of changes in the structure of the material, characterised in that
the instrumentation comprises a sensor, or several sensors mutually spaced apart, in contact with the surface of the material, and the sensor(s) is(are) arranged to emit and receive signals to provide an acoustic network with information about the structure of the material, and
that the received acoustic signals are compared with previous acoustic signals to show structural changes in the solid material,
any occurrences of defects in the solid material, and also the position of such defects.

11. System according to claim 10, characterised in that
when one or more sensors are used, each individual sensor is arranged to communicate with a master sensor, and
that the master sensor is arranged to regulate the emission and reception, respectively, of acoustic signals by the sensors.

12. System according to one of the claims 10-11, characterised in that each individual sensor is connected to the master sensor via cables.

13. System according to claims 9-11, characterised in that the master sensor is arranged to control the time of emission of acoustic signals from each sensor, and also the used frequency characteristics.
